(19) United States
(12) Patent Application Publication
(10) Pub. No.: US 2024/0224908 A1
(43) Pub. Date: Jul. 11, 2024

(54) TOP-DOWN AIRFLOW HANDLING AND DISTRIBUTION SYSTEM FOR VERTICAL PLANT GROWING SYSTEMS AND A VERTICAL PLANT GROWING SYSTEM COMPRISING THE SAME

(71) Applicant: THE GROWCER INC., Ottawa (CA)

(72) Inventors: James BOIVIN, Ottawa (CA); David Mark MACNAB, Ottawa (CA)

(21) Appl. No.: 18/563,902

(22) PCT Filed: May 20, 2022
(86) PCT No.: PCT/CA2022/050799

§ 371 Date: Nov. 23, 2023

Related U.S. Application Data
(60) Provisional application No. 63/192,713, filed on May 25, 2021.

(51) Int. Cl. A01G 31/06

(52) U.S. Cl. CPC A01G 31/06

(57) ABSTRACT

The invention provides an airflow handling and distribution system for vertical plant growing systems and a vertical plant growing system comprising the same. The airflow handling and distribution system is configured to direct air flow into the growing canopy thereby reducing problems associated with pockets of humidity collecting under the canopy.

### FIELD OF THE INVENTION

This invention pertains generally to agriculture systems, more particularly to an air handling and distribution system for self-contained vertical, hydroponic farms and, more particularly to a system configured to provide top-down airflow to plants growing in deep-water culture (DWC) systems.

### BACKGROUND OF THE INVENTION

Vertical farms by utilizing indoor farming techniques and controlled-environment agriculture (CEA) technology can be used for commercial or large-scale production of plants including crop plants, fruit, vegetables and Cannabis year-round. In vertical farms plants are grown in vertically stacked layers thereby increasing potential plant yield per square meter.

Vertical indoor farming provides an entirely controlled environment for the growth of plants by controlling factors such as light, humidity, air flow and temperature and as a result can provide a consistently high-quality product regardless of outdoor conditions.

Although vertical indoor farms are not impacted by changes in weather, vertical indoor farms are susceptible to factors that impact outdoor farming including disease and pests and may be more susceptible to rot, mildew and mold. In particular, as air moves through tightly packed racks above the plant canopy pockets of humidity form inside and under the canopy where mold and plant diseases can fester. Existing solutions to the airflow problem have involved monitoring airflow, optimizing layout of the farm and the use of booster fans along the runway length. These solutions do not however eliminate the creation of pockets of humidity in the plant canopy.

Accordingly, there exists a need for a system that overcomes the deficiencies of the prior systems.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a top-down airflow handling and distribution system for vertical plant growing systems. In accordance with an aspect of the present invention, there is provided an airflow handling and distribution system for a vertical plant growing system, the vertical plant growing system comprising a shelving system comprising a plurality of shelves; the airflow handling and distribution system comprising: an air header for operative connection to an air distribution fan; wherein the air header comprises at least one vertically oriented pipe having a height at least or substantially corresponding to the height of the shelving system, the vertically oriented pipe including a plurality of vertically spaced connectors, and a plurality of distribution lines, wherein each distribution line runs the length of a shelf is operatively connected to the vertically oriented pipe via a connector and has at least one air hole at intervals along the length of the distribution line; wherein when installed, each distribution line runs parallel and proximal to the underside of a shelf and wherein each air hole is located to direct air downwards towards each planting slot on a shelf that is below the shelf it is under.

In accordance with another aspect of the invention there is provided a vertical plant growing system comprising at least one shelving system comprising a plurality of shelves; and the airflow handling and distribution system comprising: an air header for operative connection to an air distribution fan; wherein the air header comprises at least one vertically oriented pipe having a height at least or substantially corresponding to the height of the shelving system, the vertically oriented pipe including a plurality of vertically spaced connectors, and a plurality of distribution lines, wherein each distribution line runs the length of a shelf is operatively connected to the vertically oriented pipe via a connector and has at least one air hole at intervals along the length of the distribution line; wherein when installed, each distribution line runs parallel and proximal to the underside of a shelf and wherein each air hole is located to direct air downwards towards each planting slot on a shelf that is below the shelf it is under.

In accordance with another aspect of the invention, there is provided a vertical plant growing system comprising: at least one shelving system comprising a top shelf, at least one middle shelf and a bottom shelf, wherein the top shelf and each at least one middle shelf comprises at least distribution line running along the underside of the shelf configured to supply air to the shelf below, each distribution line having at least one air hole at intervals along the length of the distribution line; and an airflow handling and distribution system comprising: an air header for operative connection to an air distribution fan; wherein the air header comprises at least one vertically oriented pipe having a height at least or substantially corresponding to the height of the shelving system, and wherein the vertically oriented pipe including a plurality of vertically spaced connectors for connection to the distribution lines.

In accordance with another aspect of the invention, there is provided a kit for the airflow handling and distribution system of the invention; wherein the kit comprises the air header and the plurality of distribution lines.

In accordance with another aspect of the invention, there is provided a shelving system for a vertical plant growing system comprising a top shelf, at least one middle shelf and a bottom shelf, wherein the top shelf and each at least one middle shelf comprises at least distribution line running along the underside of the shelf configured to supply air to the shelf below, each distribution line having at least one air hole at intervals along the length of the distribution line; wherein the distribution lines are configured for connection to air supply.

In accordance with another aspect of the invention, there is provided a shelving system for a vertical plant growing system comprising a top shelf, at least one middle shelf and a bottom shelf, wherein the top shelf and each middle shelf comprises at least one distribution line running along the underside of the shelf configured to supply air to the shelf below, each distribution line having at least one air hole at intervals along the length of the distribution line; wherein the distribution lines are configured for connection to air supply.

### BRIEF DESCRIPTION OF THE DRAWINGS

These and other features of the invention will become more apparent in the following detailed description in which reference is made to the appended drawings.

FIG. 1 illustrates an end view of one embodiment of the vertical growing system (10) housed within a shipping container (15) detailing two shelving systems (20) and a top-down airflow handling and distribution system (30). Also shown are components of the deep-water culture (DWC) system including DWC ponds (40) and pond supply pipes (45) with shutoffs (47) at each level.

FIG. 2 illustrates a partial, cut away side view of the embodiment of FIG. 1 with pond supply pipes not installed detailing one of shelving systems (20) and half of the top-down airflow handling and distribution system (30). An upright duct (32) connected to two distribution lines (34) per shelf level via an elbow duct connector (36) are shown. Also shown are DWC ponds (40).

FIG. 3 illustrates a three-dimensional view of the embodiment of FIG. 1. The air header of the top-down airflow handling and distribution system are not shown.

FIG. 4A illustrates a detailed view of part of the undershelf of the vertical growing system of FIG. 1 detailing two distribution lines (34) and lighting (50).

FIG. 4B illustrates a detailed view of part of the undershelf of the vertical growing system of FIG. 1 detailing upright duct (32) connected to two distribution lines (34) per shelf level via an elbow duct connector (36). Each distribution line is provided with holes 38 at intervals along its length. Also shown is undershelf lighting (50).

FIG. 5 illustrates end views of the vertical growing system of FIG. 1 detailing components of the deep-water culture (DWC) system including DWC ponds (40). (A) At the inlet end, liquid is input to the inlet 46 of the DWC by pond supply pipes (45) with shutoffs (47) at each level. (B) At the opposite end, a pond outlet (48) is provided with connected drain lines (49). Each pond outlet is optionally provided with a filter to provide debris from clogging the drain lines. The air header of the top-down airflow handling and distribution system are not shown. (C) Detailed view of drain is shown.

FIG. 6 illustrates an alternative view of FIG. 5.

FIG. 7 illustrates an alternative embodiment where the vertical growing system wherein distribution line duct connection is integrated to the shelf ends. End cap (60) with integrated duct connection and duct caps (62) are detailed.

FIG. 8 illustrates the alternative embodiment of FIG. 7 as levels of where the vertical growing system.

FIG. 9 illustrates various views of one embodiment of the vertical growing system housed within a shipping container (partial shown) detailing two shelving systems and a top-down airflow handling and distribution system.

FIG. 10 illustrates an alternative view of the embodiment of FIG. 9.

FIG. 11 illustrates the embodiment of FIG. 10 with two shelving systems removed.

### DETAILED DESCRIPTION OF THE INVENTION

The invention provides an airflow handling and distribution system for vertical plant growing systems and a vertical plant growing system comprising the same. The vertical plant growing system is modular and can be readily adapted for a variety of sized spaces including but not limited to shipping containers. In addition to the airflow handling and distribution system, the vertical plant growing system includes a shelving system and a hydroponic growth system, wherein each shelf is optionally configurable to be growing level. In preferred embodiments, the hydroponic growth system is a deep-water culture system. The vertical growing system may be configured for robotic automation.

In the system, air distribution is provided by air distribution tubes in the plane immediately above each canopy, these air distribution tubes are configured to direct air downwards towards the center of each planting slot as plants grow. Air is suppled to the distribution tubes via a header attached to a distribution fan or air supply. The distribution fan is sized to ensure the fan is capable of fully pressurizing the distribution tubes it supplies. The distribution fan will pull, optionally pre-conditioned, air from HVAC or mixing box.

The size and capacity of an indoor farm may be modified by adjusting the dimensions of the vertical growing system and/or number of shelves. In addition to or alternatively, the size and capacity of an indoor farm may be modified by using multiple modules of the vertical growing system.

The size and capacity of the air distribution system will depend on the size of the vertical growing system. The size and capacity may be modified depending on height and number of shelves. The number of air distribution tubes provided per growing level may be dependent on shelf width. In some embodiments, one air distribution tube is provided per growing level. In other embodiments, two air distribution tubes are provided per growing levels. The airflow handling and distribution system may be configured to shut off air flow to individual air distribution tubes.

The velocity of the inputted air results in an exchange of air below the canopy and increased movement of air around individual plants resulting in a higher transpiration rate which may positively impact plant growth. By replacing more saturated air close to the plants with drier air, the plants are less disease-prone. Improving movement of air around individual plants allows for increased plant density.

The airflow handling and distribution system is connected to an air supply. Optionally, air temperature and/or humidity is controlled and may be optimized for the plants being grown.

Components of the airflow handling and distribution system may be manufactured on from PVC pipe or other appropriate material known in the art.

The distribution tubes may have any cross section. In some embodiments, the distribution tubes are configured to have a low profile to reduce interference with the canopy of the growing plants. The distribution tubes are provided with at least one air hole at intervals along the length of the distribution line such that air is directed to the shelf below. In some embodiments, a row of air holes is provided at intervals. The row may include two, three, four or more holes. Holes may optionally be provided along one or more edges of the distribution tubes. Each distribution tube is capped at one end, optionally the cap is removable, and removably connectable to the air header which supplies optionally conditioned air to the tubes. Attachment to the air header is optionally via a connector. In some embodiments, the connector is an elbow duct connector. In some embodiments, the connector is flexible, optionally the flexible connector is an accordion duct.

Optionally, different diameter or profile distribution tubes may be connected to the header via the use of different connectors.

In some embodiments, the distribution tubes are connected to either framing elements and/or the underside of a shelf by fasteners now in the art. Optionally, the framing elements and/or the underside of the shelves are equipped with clips configured to rapidly secure the distribution tubes in place. In other embodiments, the distribution tubes or parts thereof are components of the shelving system and thus may be integrated into the shelves or permanently attached to the shelving system.

In some embodiments, the shelving system comprises a frame and shelves. The shelving system may be manufactured from any appropriate material know in the art including steel or plastic. Optionally, the shelving system or components thereof are coated, painted or otherwise treated. The decking of the shelves is optionally configured to allow drainage and accordingly may be manufactured from wire mesh or other material known in the art.

The shelving system is optionally configured to be moved and thus may include wheels, rollers or casters, each of which are optionally lockable.

Referring to the Figures, wherein like reference numerals refer to the same or similar features in the various views.

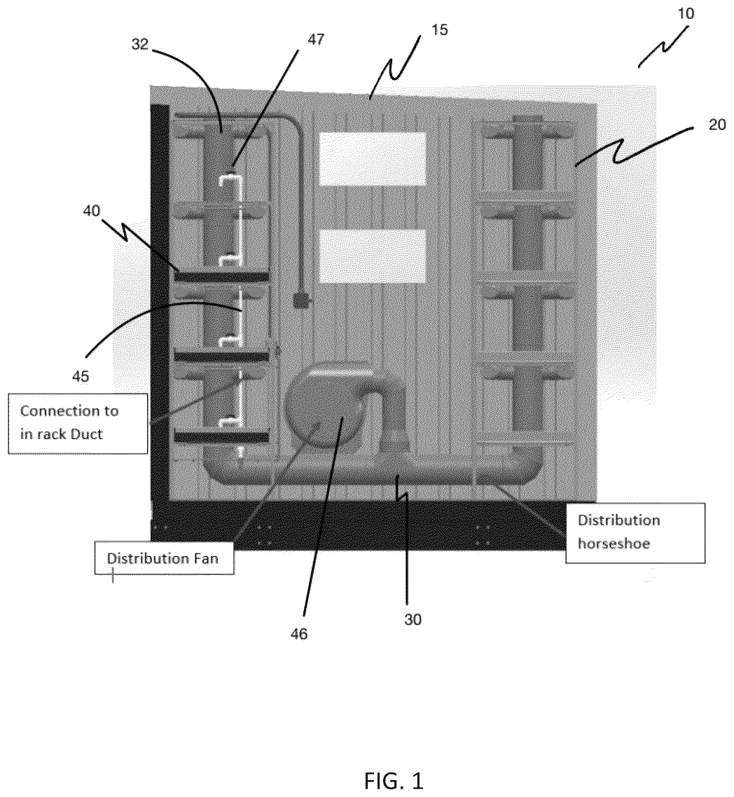

FIGS. 1 to 5 shows part of a vertical farming system (10) housed within a shipping containing (15) and having precision climate controls. In the illustrated embodiment, the vertical farming system (10) comprises two shelving systems (20) configured to support hydroponic cultures, specifically deep-water culture (DWC) and a top-down airflow handling and distribution system (30).

Each self or level is optionally at a slight decline to allow for more efficient gravity-based irrigation and draining of the system and gravity-based loading and unloading. In some embodiments, the shelf decline angle is between 1 and 5 degrees and preferably 2 degrees, however, other angles can be used for the same purpose. The vertical farming system can be any length and height. In some embodiments, the vertical farming system is sized to fit within a standard shipping container. Optionally, shelf height is adjustable to account for canopy height of plants being grown. In embodiments, with adjustable shelves, the air distribution system is configured to allow for shelf adjustment.

In the illustrated embodiment, a single air distribution system (30) supplies air to two shelving systems (20). The air distribution system comprises a U-shaped air header for operative connection to an air distribution fan (46) via a centrally located air input duct. The U-shaped air header is installed at one end of the shelving system. Where the vertical farming system housed within a shipping containing the U-shaped air header is attached to a back wall of the container.

The substantially parallel upright ducts (32) of the U-shaped air header correspond substantially in height to the height of the shelving system and are closed at the ends. The header and fan (46) are sized to ensure the fan is capable of fully supplying the system with air at the necessary velocity. Optionally, the fan is a variable drive fan (VDF). In such embodiments, air flow may be adjusted as needed, for example, depending on the growth stage of the plant.

The U-shaped header is manufactured of material appropriate for a HVAC system and have various duct cross sections. In some embodiments, the U-shaped header comprises 8″ ducts. In some embodiments, the ducts are round aluminum ducts.

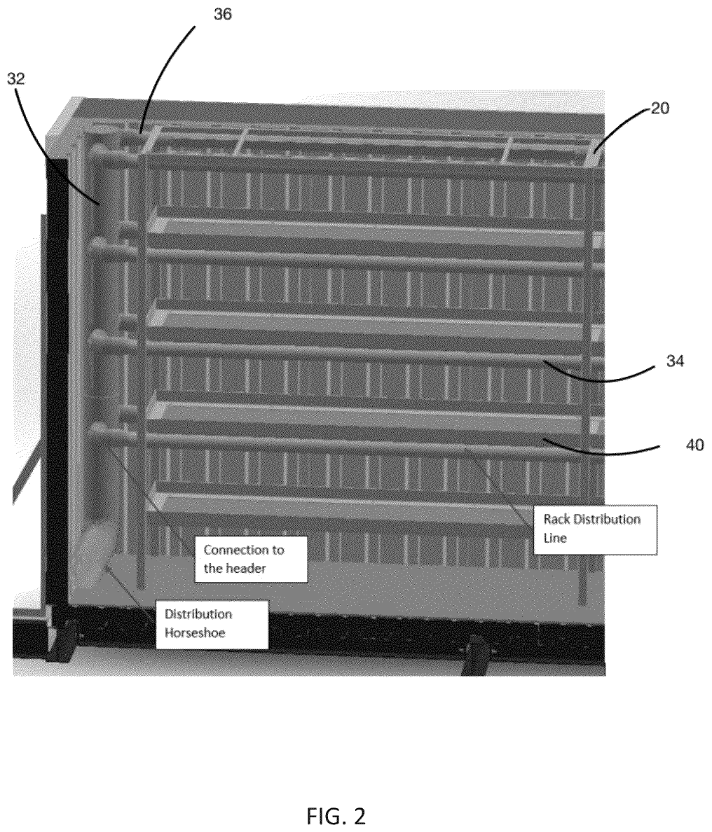

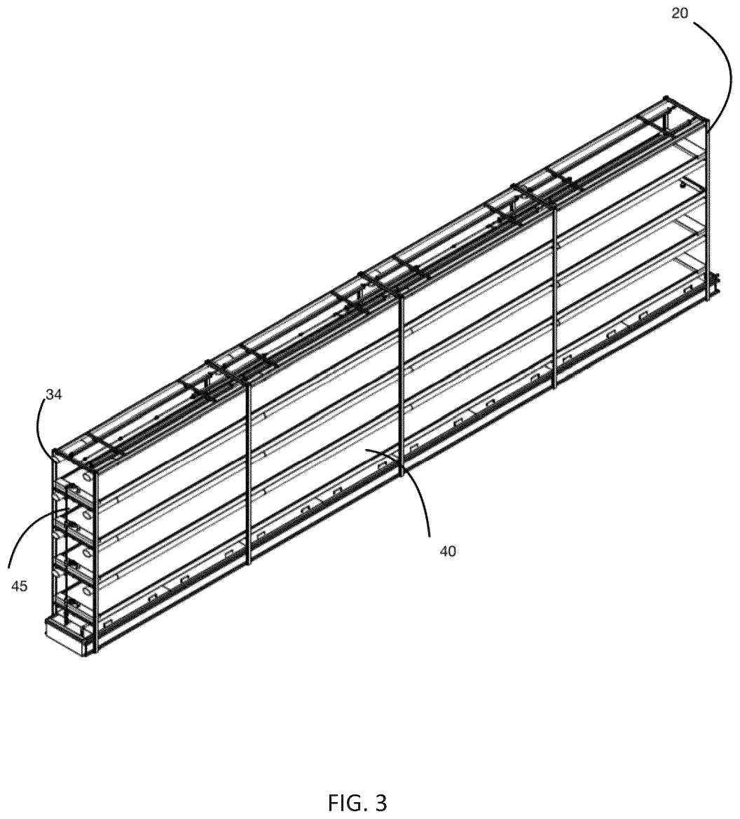

The parallel upright ducts (32) comprise a plurality of connection points for connection to a distribution line. Referring to FIGS. 2 and 3, in the illustrated embodiment, each upright duct is connected to two distribution lines (34) per shelf level. As illustrated, each connection may be via an elbow duct connector (36). Alternatively, flexible ducting may be used to connect the header to the distribution lines. In some embodiments, fittings are provided to facilitate rapid connection of the distribution lines to the header. Optionally, the connection points are capped when not connected to a distribution line.

Referring to FIGS. 2 and 3, each level of the vertical growing system is equipped with two substantially parallel above canopy distribution lines (34) running substantially the full length of the shelf. Each distribution line (34), except for those at the top level, is secured to the bottom side of the shelf or supports thereof of the level above the level it supplies. The distribution lines (34) at the top level are secured to the frame of the shelving system.

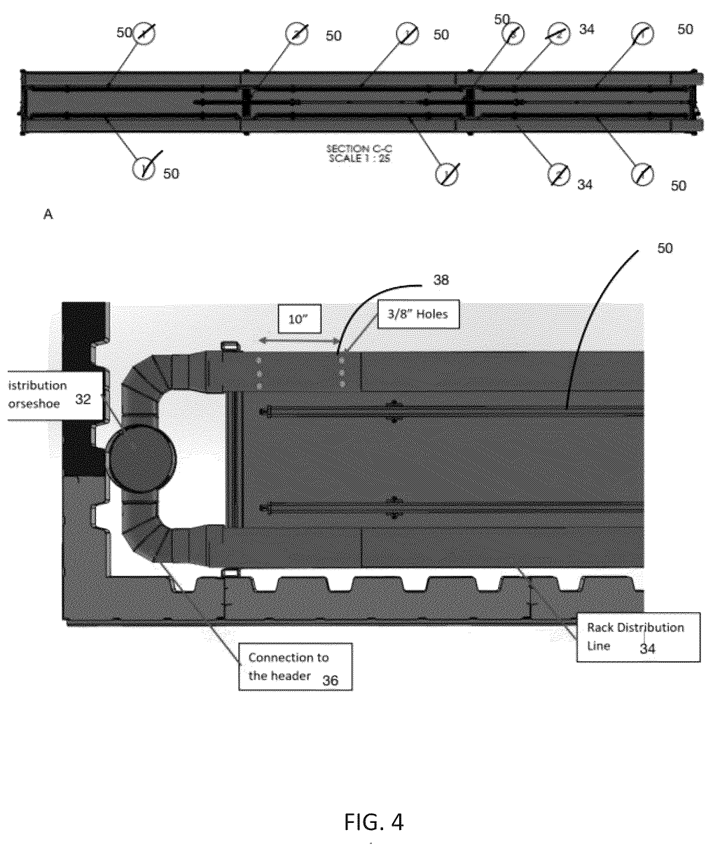

Referring to FIG. 4, each distribution line is perforated along its length, optionally at intervals that correspond to growth slots. Grow lights (50) may be provided on the underside of shelves.

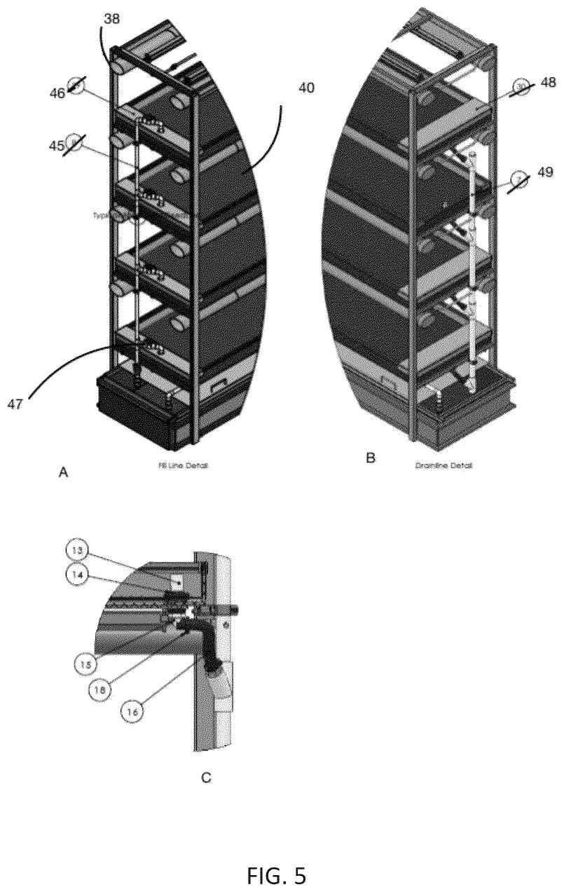

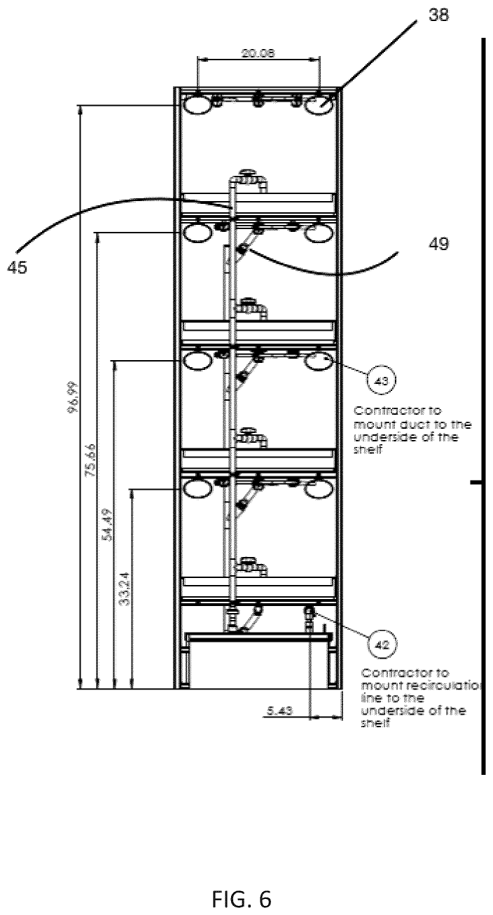

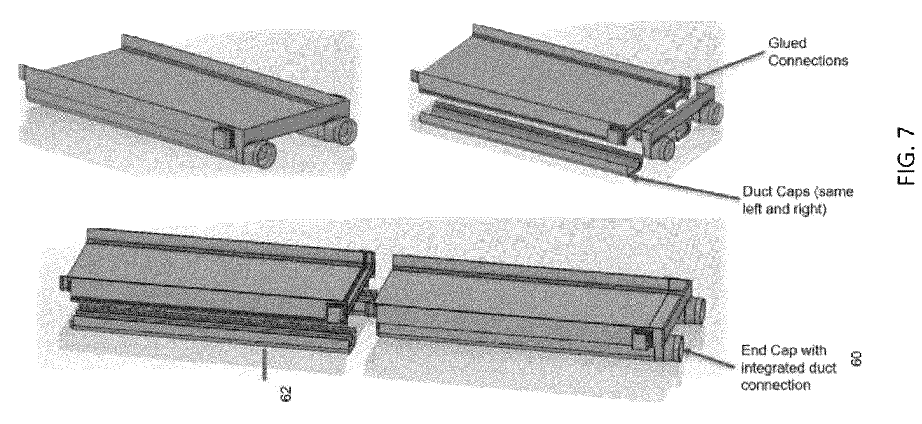

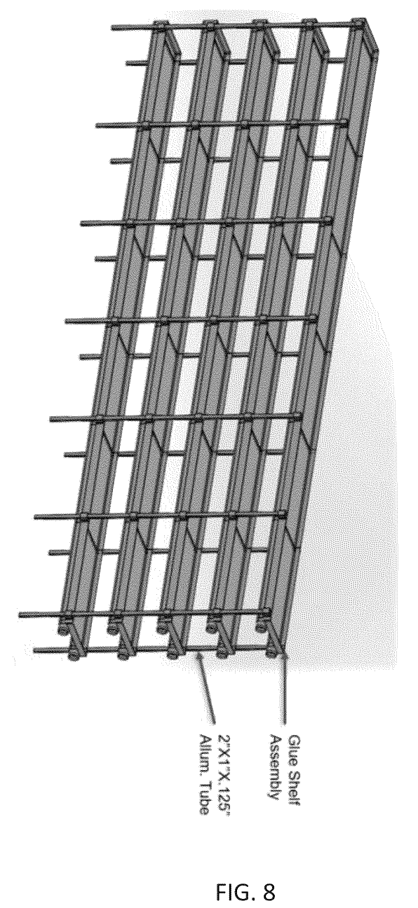

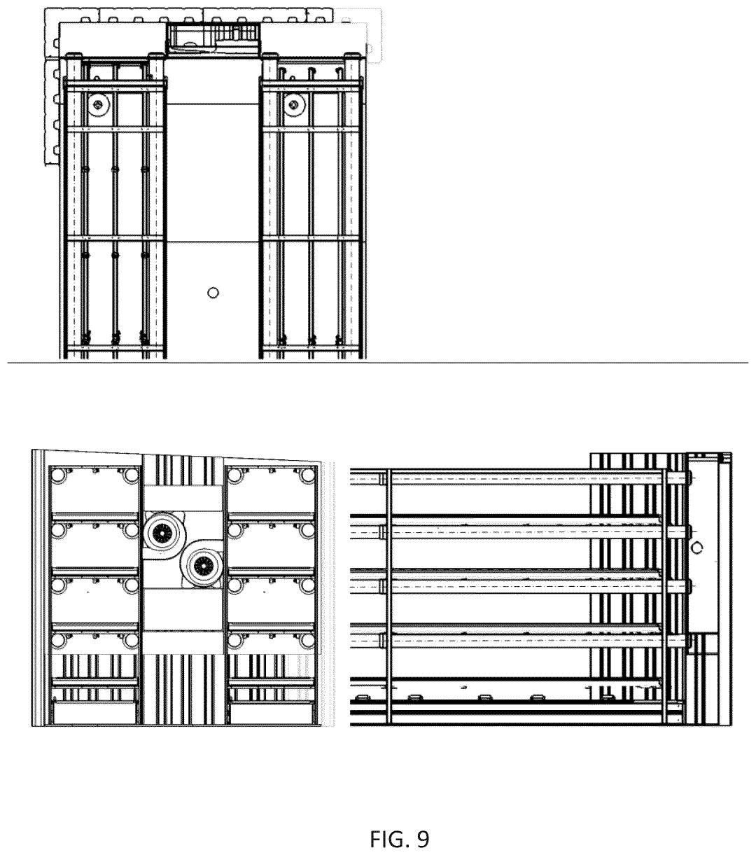

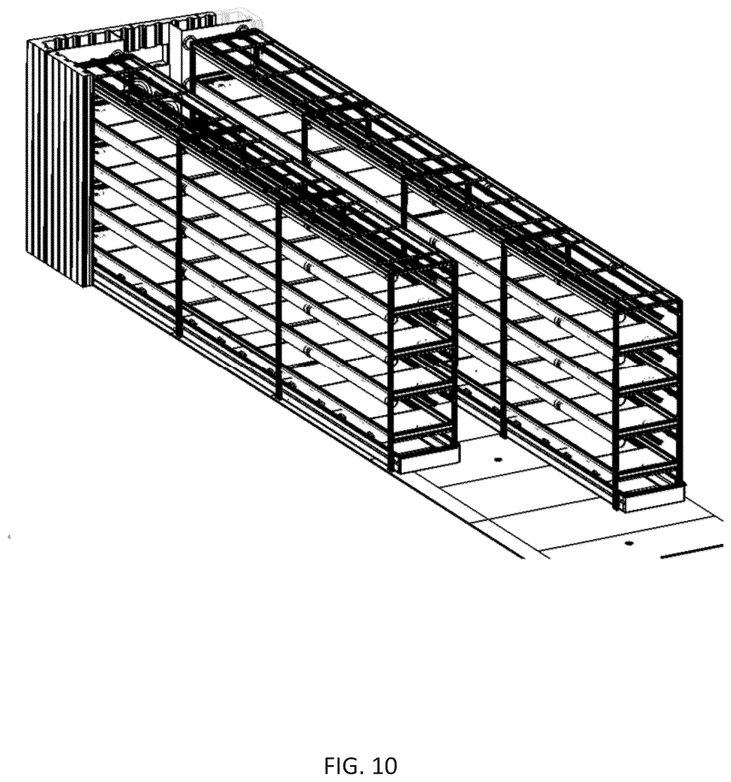

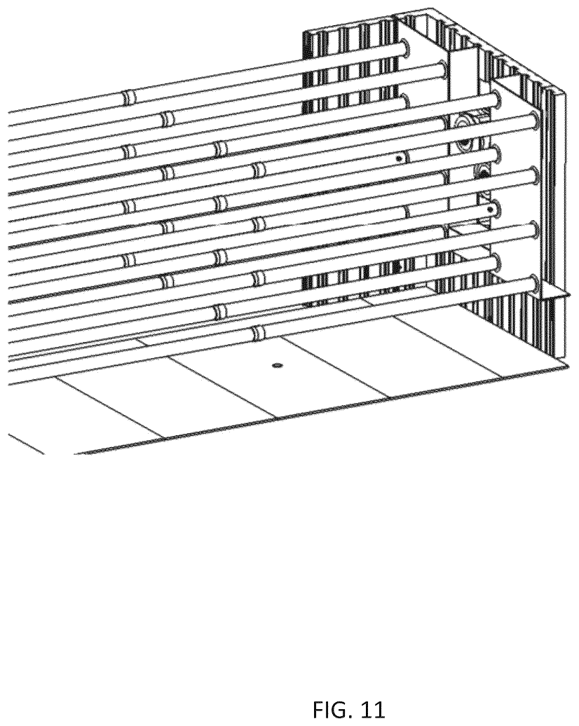

Referring to FIGS. 5 and 6, in some embodiments, the vertical growing system is a deep-water culture (DWC) system. In such embodiments, the shelving system is configured to accommodate the components of the deep-water culture (DWC) system. Each shelf of the shelving system is provided with a DWC ponds (40). Each pond is filled using the inlet (46) supplied by pond supply pipes (45) with shutoffs (47). Each shell is also provided with a pond outlet (48) connected to drain lines (49). Each pond outlet is optionally provided with a filter to provide debris from clogging the drain lines.

In some embodiments, the distribution lines are a component of the shelf. In such embodiments, the underside of the shelf is provided with parallel beads or strips of plastic to which corresponding grooves on the duct caps snap on to. Alternatively, the underside of shelves of each shelf is provided with the grooves and the duct caps snap into the grooves. The duct caps include air holes. Spacing and size of the air holes may be adjusted by replacing the duct caps. Alternatively, the different duct caps may be used to change the profile of the ducts.

In some embodiments, the duct work is directly integrated into the shelves themselves by injection molding.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. An airflow handling and distribution system for a vertical plant growing system, the vertical plant growing system comprising a shelving system comprising a plurality of shelves;
the airflow handling and distribution system comprising:
an air header for operative connection to an air distribution fan; wherein the air header comprises at least one vertically oriented pipe having a height at least or substantially corresponding to the height of the shelving system,
the vertically oriented pipe including a plurality of vertically spaced connectors, and
a plurality of distribution lines, wherein each distribution line runs the length of a shelf is operatively connected to the vertically oriented pipe via a connector and has at least one air hole at intervals along the length of the distribution line; wherein when installed, each distribution line runs parallel and proximal to the underside of a shelf and wherein each air hole is located to direct air downwards towards each planting slot on a shelf that is below the shelf it is under.

2. The airflow handling and distribution system of claim 1, wherein the at least one air hole is a line of at least two, three or four air holes.

3. The airflow handling and distribution system of claim 1, wherein the air header is a U-shaped header comprising two vertically oriented pipes.

4. The airflow handling and distribution system of claim 1, wherein the vertically spaced connector is flexible.

5. The airflow handling and distribution system of claim 1, wherein two connectors are provided on each level.

6. The airflow handling and distribution system of claim 1, wherein the distribution lines are low profile.

7. The airflow handling and distribution system of claim 1, wherein the distribution lines have an oval cross section.

8. A kit for the airflow handling and distribution system of claim 1, wherein the kit comprises the air header and the plurality of distribution lines.

9. A vertical plant growing system comprising:
at least one shelving system comprising a plurality of shelves; and the airflow handling and distribution system of claim 1.

10. The vertical plant growing system of claim 9, comprising an air distribution fan.

11. The vertical plant growing system of claim 9, wherein each distribution line is reversible connected to the shelf above it.

12. The vertical plant growing system of claim 9, comprising two shelving systems.

13. The vertical plant growing system of claim 9, wherein said vertical plant growing system is configured as a vertical hydroponic system.

14. The vertical plant growing system of claim 13, wherein the hydroponic system is a deep-water culture system and each shelf is configured to support a deep-water culture system pond.

15. A vertical plant growing system comprising:
at least one shelving system comprising a top shelf, at least one middle shelf and a bottom shelf, wherein the top shelf and each middle shelf comprises at least one distribution line running along the underside of the shelf configured to supply air to the shelf below, each distribution line having at least one air hole at intervals along the length of the distribution line; and
an airflow handling and distribution system comprising:
an air header for operative connection to an air distribution fan; wherein the air header comprises at least one vertically oriented pipe having a height at least or substantially corresponding to the height of the shelving system, and wherein
the vertically oriented pipe including a plurality of vertically spaced connectors for connection to the distribution lines.

16. A shelving system for a vertical plant growing system comprising a top shelf, at least one middle shelf and a bottom shelf, wherein the top shelf and each at least one middle shelf comprises at least distribution line running along the underside of the shelf configured to supply air to the shelf below, each distribution line having at least one air hole at intervals along the length of the distribution line; wherein the distribution lines are configured for connection to air supply.
